(19) United States
(12) Patent Application Publication
(10) Pub. No.: US 2014/0223195 A1
(43) Pub. Date: Aug. 7, 2014

(54) Encrypted Storage Device for Personal Information

(71) Applicant: Ju Long Wei, Taichung City (TW)

(72) Inventor: Ju Long Wei, Taichung City (TW)

(21) Appl. No.: 13/975,476

(22) Filed: Aug. 26, 2013

(30) Foreign Application Priority Data
Feb. 1, 2013 (TW) 102103874

(51) Int. Cl. G06F 12/14; H04L 9/06

(52) U.S. Cl. CPC G06F 12/1408; H04L 9/0631
USPC 713/190

(57) ABSTRACT

An encrypted storage device for personal information has a control module, a plug and play interface and a storage unit. The Control module has an encryption module and a processing module electrically connected the encryption module and driving the encryption module to perform an encryption/decryption operation. The plug and play interface is electrically connected to the Control module and is adapted to connect with a computer to transmit information to the Control module. The storage unit is electrically connected to the Control module and has a public data area and an encryption area. The public data area has at least one application. The encryption area is used to store the encryption algorithm information, and the encryption algorithm information can be read after identity authenticating and decrypting.

### BACKGROUND OF THE INVENTION

1. Field of Invention

The present invention relates to an encrypted storage device, and more particularly to an encrypted storage device for personal information that can improve the security of using the encrypted storage device significantly.

2. Description of the Related Art

Rapid development of information technology has brought great convenience and unprecedented innovation to people's life in all fields. A conventional electronic health insurance card is widely used in the medical industry, which contains the patient's name, age, social security number and health insurance account and gradually replaces the paper forms. However, the patients still have a lot of inconvenience in the process of seeking treatment, such as the Digital radiography (DR) of a direct digital X-ray imaging system, the electronic computer X-ray tomography Technique (CT) and the other medical imaging information that can help the doctors to diagnose, analyze and positioning the patients' diseases. The aforementioned information is usually carried and stored in the compact discs (CD), films, printed papers and the like media. However, these media cannot be stored easily for a long time, cannot be reused or is not environmental friendly.

With the improvement of the standards of the hospital information, a conventional medical image data storage device for an improved conventional health insurance card can be used to store high capacity information, can provide multi-function and has a main control chip. The main control chip has a flash memory chip. The main control chip is connected to the flash memory chip by a Serial Peripheral Interface BUS (SPI), a multi-master serial single-ended computer bus (I-two-C/I2C interface) or the like communication interfaces. The flash memory chip might have a capacity of 1 GB or larger size to store basic information of a medical insurance card and can provide communication interfaces of a health insurance card information and an electronic medical records information. The communication interfaces of the health insurance card information and the electronic medical records information are respectively used to connect to a health insurance executive information system and a hospital management information system. The electronic medical records information includes the patient's height, blood type, family health history, detailed medical records and medical images.

However, the aforementioned medical information in the conventional storage device is not encrypted or is software encrypted, and this is no privacy to the patients and the personal medical information is easy to be hacked or viruses infected.

Furthermore, when the mobile portable storage device is connected to a USB serial port, the user needs to install a suitable driver or software before read out the information and this will increase complexity in use.

The present invention provides an encrypted storage device for personal information storage to obviate or mitigate the shortcomings of the conventional medical image data storage device for a health insurance card.

### SUMMARY OF THE INVENTION

The primary objective of the present invention is to provide an encrypted storage device for personal information that can improve the security of using the encrypted storage device significantly.

The encrypted storage device for personal information has a Control module, a plug and play interface and a storage unit. The Control module has an encryption module and a processing module electrically connected the encryption module and driving the encryption module to perform an encryption/decryption operation. The plug and play interface is electrically connected to the Control module and is adapted to connect with a computer to transmit information to the Control module. The storage unit is electrically connected to the Control module and has a public data area and a encryption area. The public data area has at least one application. The encryption area is used to store the encryption algorithm information, and the encryption algorithm information can be read after identity authenticating and decrypting.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an encrypted storage device for personal information in accordance with the present invention;

FIG. 2 is a block chart of the encrypted storage device for personal information in FIG. 1, connected to a computer via a USB port;

FIG. 3 is an operational perspective view of the encrypted storage device for personal information in FIG. 1; and

FIG. 4 is a flow chart of encryption algorithm steps of the encrypted storage device for personal information in FIG. 1.

### DETAILED DESCRIPTION OF THE INVENTION

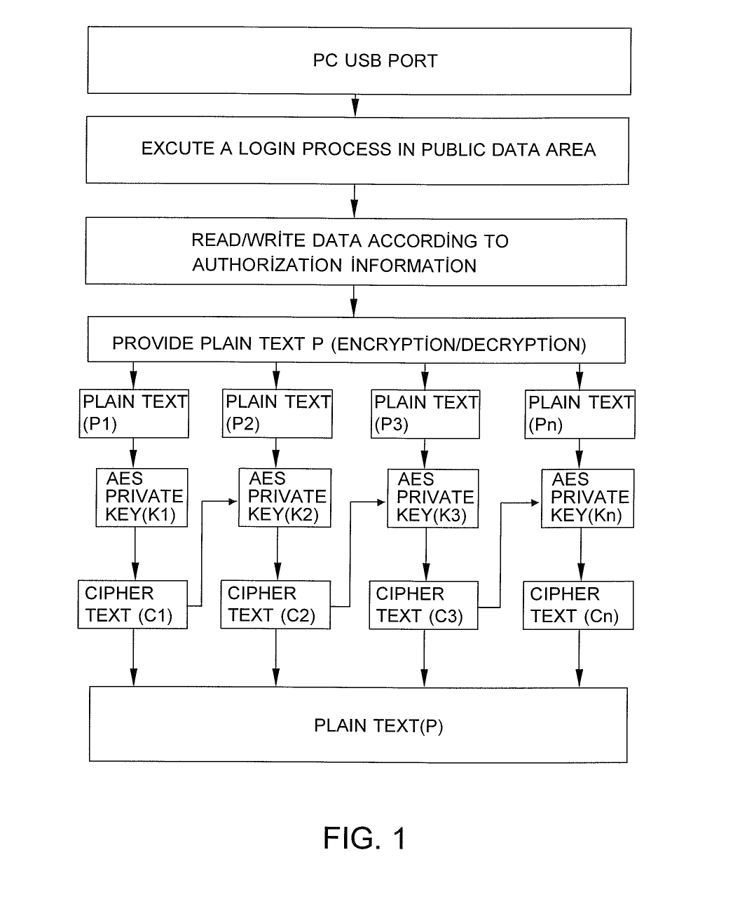

With reference to FIGS. 1 to 3, a preferred embodiment of an encrypted storage device for personal information in accordance with the present invention may be made as a card having a body and a connecting interface pivotally connected to the body and comprises a control module 2, a plug and play interface 1 and a storage unit 3. The card may be a size like credit card, business card or the like that is convenient to be inserted or saved into a wallet.

The control module 2 is mounted in the body of the card. In the preferred embodiment of the present invention, the control module 2 is a circuit with an ARM structure. The control module 2 has at least one firmware module, an encryption module and a processing module. The processing module is electrically connected to the at least one firmware module and the encryption module, has an embedded program to process external information and is used to control to read, to delete and to modify permission commands of a data. In addition, the encryption module is driven to perform encryption/decryption operations by the processing module.

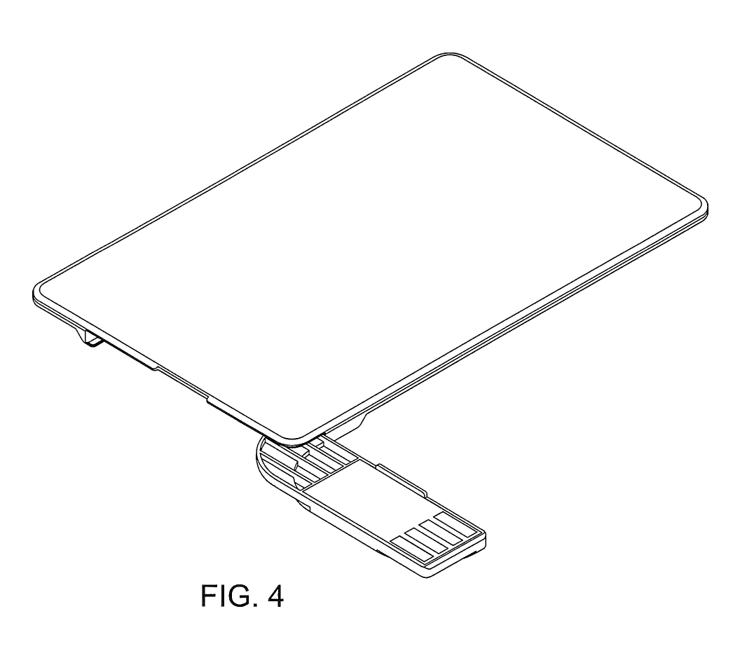

In the preferred embodiment of the present invention, the encryption module uses a serial AES (Advanced Encryption Standard) encryption algorithm which including three block encoders: AES-128 (128-bit key), AES-192 (192-bit key) and AES-256 (256-bit key). The encryption module is a hardware encryption/decryption arithmetic circuit. The hardware AES encryption algorithm significantly improves a processing speed that is close to a speed processing unencrypted information. With reference to FIG. 4, the encryption module is an AES chip and has a plain text (P1, P2, P3, . . . , Pn) and a cipher text (C1, C2, C3, . . . , Cn). The plain text is embedded with the block encoders. The cipher text is formed by entering private keys (K1, K2, K3, . . . , Kn) in the AES encryption algorithm and is generated by the AES encryption algorithm. In a decryption process, a user needs to enter the private keys to the AES encryption algorithm to form the original plain text. The at least one firmware module is used to store the plain text or the private keys and also can protect stored information by the aforementioned encryption algorithm method or other encryption algorithm methods.

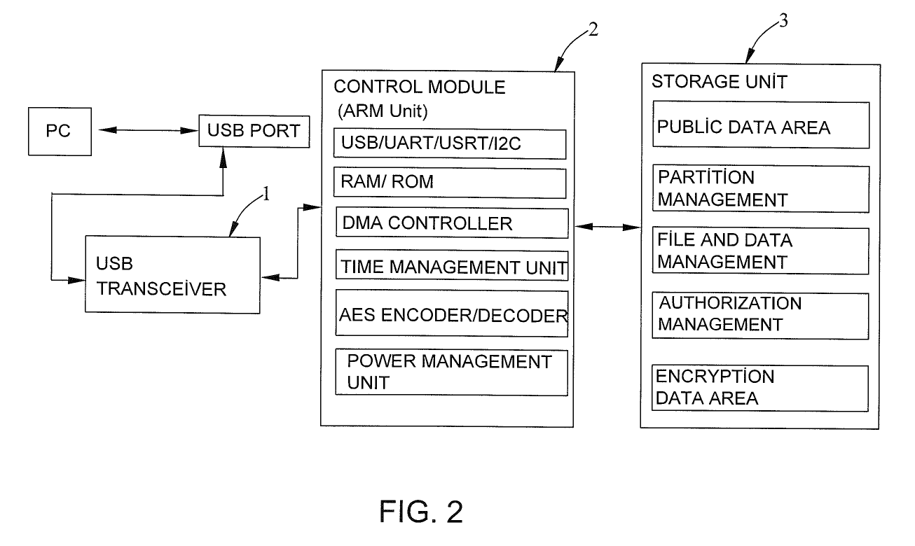

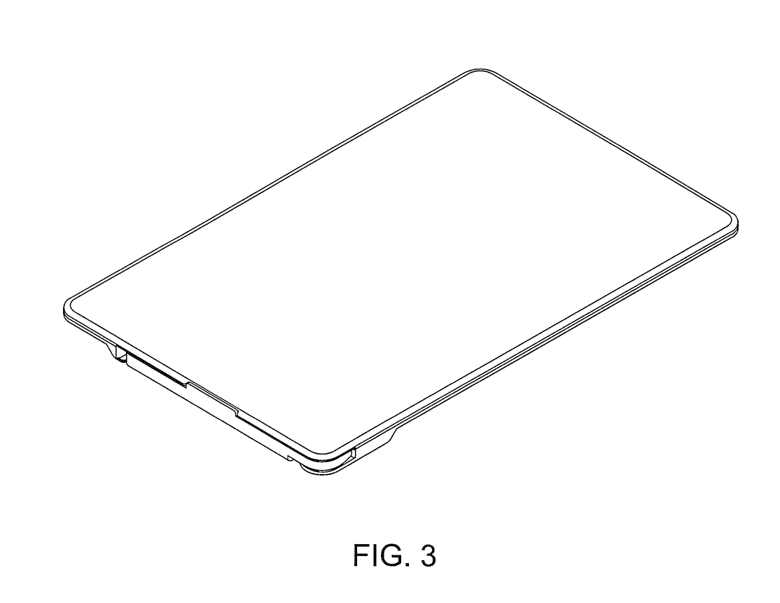

The plug and play interface 1 is electrically connected to the control module 2 and is a transmission interface for connecting to a computer or an electrical platform, such as USB 1.1 to 3.0, SATA or Thunderbolt. In the preferred embodiment of the present invention, the plug and play interface 1 is a USB interface and is connected to and transmitted signal with a computer 50 as shown in FIG. 2. In addition, the plug and play interface 1 is mounted on the connecting interface of the card for providing the preferred embodiment to be connected to the computer 50 and is shown as FIG. 3.

The storage unit 3 is electrically connected to the control module 2, may be a non-temporary memory such as a flash memory (NAND Flash) and a solid-state hard drive. The storage unit 3 has a public data area and an encryption area. The public data area provide a storage space for applications and reading data when the plug and play interface 1 is connected to the computer 50. The applications include different execute permissions and are subjected to password authentication by default to allow users with different permissions to read specific information or perform applications.

The encryption area is used to store the encryption algorithm information. The encryption algorithm information that is stored in the encryption area can be read after identity authenticating and decrypting. In addition, the encryption area is a hidden memory area. The storage unit 3 has different forms of partition memory for the public data area and the encryption area. In the present invention, the storage unit is a NAND flash memory, wherein the encryption area is the last one logical unit (LUN) memory block and is used to store the private keys of the AES encryption algorithm. The encryption algorithms uses 256-bit key. When the user enters the correct private key passwords, the control module 2 may read the public and private keys from different sources which providing a better data protection result for personal information.

Furthermore, the storage unit 3 may have multiple encryption areas, and each one of the encryption areas has a different private key to encrypt information and to store the information therein. The information that is stored in the different encryption areas may be corresponding to a specific application to open a specific file format. For example, the preferred embodiment of the present invention can be applied to store patient's medical information, such as the medical images (X-ray, tomography and nuclear magnetic resonance etc.) and the inspection reports etc. Different encryption areas depending on permissions setting are used to store different specific information including corresponded application to open the specific file format such as the medical image viewing software. Consequently, the users can open the corresponding authorization information by passing through the identity authentication without installing a special application in the computer 50.

Additionally, the storage unit 3 has multiple public data areas with different file formats, the storage unit 3 can store the information with different file formats in the public data areas by a data partition management unit and can be used to store information with different purposes or different users in the public data areas by a file folder management unit. Each one of the different users has a specific folder and may predefine a password to protect the information in the specific folder or use the encryption algorithms to encrypt the information in the specific folder.

In order to manage the users with different permissions to open information, the storage unit 3 may further has an authorization management unit to store different permission information for the users. The user can read authorized documents or information via login with the password.

With reference to FIGS. 1 and 3, the connecting interface can be rotated relative to the body of the card to connect with the computer 50 to transmit information. After transmitting the information, the connecting interface can be rotated return the original position below the body of the card and this is convenient in storage and transport. Furthermore, the connecting interface is pivotally connected to a corner of the body of the card and this enable the connecting interface to rotate with a large angle and the connecting interface can be used conveniently.

The encrypted storage device for personal information as described has the following advantages.

1. The encrypted storage device in accordance with the present invention can provide access information confidentially and multi-layer authentication outcome to the personal information, and also can manage the users with different permissions.

2. The encrypted storage device in accordance with the present invention is an embedded software system (Chip On System; COS), and the users store/read a medical images and reports with high reliability of data encryption under different permission levels without pre-installed applications into the computer 50. Relative to the conventional medical image data storage device, the encrypted storage device for personal information in accordance with the present invention improves the user's privacy, the data shall be subject to different license to access and this can provide better storage protection. In addition, the present invention has advantages of mobility, high-speed access, privacy, and reusability and permanent preservation. Then, the safety and quality of the medical image diagnostic information can be improved.

3. The encrypted storage device for personal information in accordance with the present invention uses the AES encryption algorithm and is suitable for applications such as the medical images viewer or the test reports with special file format. The private keys that are encrypted by the AES encryption algorithm are stored in the encryption areas. Then, the information in the storage unit 3 can be encrypted and decrypted and this can avoid the software encryption unreliable defects and can improve the security of the data processing.

4. The encrypted storage device for personal information in accordance with the present invention has an authorization management unit to control the permission, the user can read and write the corresponding information with permission. In addition, the AES chip hardware encryption can improve the security of using the encrypted storage device significantly.

5. Non-authorized user cannot read encrypted data, the information cannot be modified, the data permanently keep the original information, and the hackers will not be able to use the calculator software interrupt decipher, chip removal crack and other methods to intercept, copy or steal the patient information.

6. The encrypted storage device for personal information uses an embedded system programming firmware encryption (Firmware Encryption on Chip the system) technology, the hackers cannot learned or read the encrypted private keys by a disassemble program.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An encrypted storage device for personal information comprising
an control module having
an encryption module; and
a processing module electrically connected the encryption module and driving the encryption module to perform an encryption/decryption operation;
a plug and play interface electrically connected to the control module and being adapted to connect with a computer to transmit information to the control module; and
a storage unit electrically connected to the control module and having
a public data area having at least one application; and
an encryption area being used to store the encryption algorithm information and the encryption algorithm information being read after identity authenticating and decrypting.

2. The encrypted storage device as claimed in claim 1, wherein
the Control module has a firmware module electrically connected to the processing module; and
the encryption module is a serial Advanced Encryption Standard (AES) encryption algorithm.

3. The encrypted storage device as claimed in claim 2, wherein
the plug and play interface is a USB, SATA, Fire Wire or Thunderbolt;
the storage unit is a non-temporary memory; and
the firmware module is used to store the encryption algorithm information that is encrypted by the encryption module.

4. The encrypted storage device as claimed in claim 3, wherein the encryption area is a hidden memory area.

5. The encrypted storage device as claimed in claim 4, wherein the storage unit is a NAND flash memory, wherein the encryption area is the last one logical unit memory block and is used to store a private key of the AES encryption algorithm.

6. The encrypted storage device as claimed in claim 5, wherein the storage unit has multiple encryption areas, each one of the encryption areas has different private key to encrypt information stored therein, and the information that is stored in the different encryption areas has an application to open a specific file format.

7. The encrypted storage device as claimed in claim 6, wherein the specific file format includes a medical image or a test report.

8. The encrypted storage device as claimed in claim 6, wherein
the storage unit has multiple public data areas with different file formats;
the storage unit can store the information with different file formats in the public data areas by a data partition management unit and can store information with different purposes or different users in the public data areas by a file folder management unit; and
each one of the different users has a specific folder and can use a password to protect the information in the specific folder or use the encryption algorithms to encrypt the information in the specific folder.

9. The encrypted storage device as claimed in claim 8, wherein
the storage unit has an authorization management unit to store different permission information of each user, and each user can read the permission documents or information via login and authentication permissions; and
each one of the public data areas has multiple applications with different authentication permissions, the users with different authentication permissions can open the corresponding authorization information by passing through the identity authentication.

10. The encrypted storage device as claimed in claim 8, wherein
the encrypted storage device is made of a card, the card has a body and a connecting interface pivotally connected to the body of the card;
the plug and play interface is mounted on the connecting interface of the card; and
the connecting interface is pivotally connected to one of the corners of the body of the card.
